(19) United States
(12) Patent Application Publication
(10) Pub. No.: US 2025/0203577 A1
(43) Pub. Date: Jun. 19, 2025

(54) REDUCED LATENCY SCHEDULING REQUEST PROCEDURES

(71) Applicant: QUALCOMM Incorporated, San Diego, CA (US)

(72) Inventors: Sagar LNU, Hyderabad (IN); Avinash Kumar DUBEY, Hyderabad (IN); Mohammad Suhel ASHFAQUE, Hyderabad (IN)

(21) Appl. No.: 18/845,328

(22) PCT Filed: Apr. 26, 2023
(86) PCT No.: PCT/US2023/020012

§ 371 Date: Sep. 9, 2024

(30) Foreign Application Priority Data
Apr. 28, 2022 (IN) 202221024980

(51) Int. Cl. H04W 72/02; H04W 72/1268; H04W 76/20; H04W 84/06

(52) U.S. Cl. CPC H04W 72/02; H04W 72/1268; H04W 76/20; H04W 84/06

(57) ABSTRACT

Certain aspects of the present disclosure provide a method of wireless communications by a user equipment, including determining an amount of data to be sent to a network entity: selecting a resource for sending a scheduling request based on the amount of data; and sending, to the network entity, a scheduling request using the selected resource.

### CROSS-REFERENCE TO RELATED APPLICATION

This application claims priority to Indian Provisional Patent Application No. 202221024980, filed Apr. 28, 2022, which is assigned to the assignee hereof and hereby expressly incorporated by reference in its entirety as if fully set forth below and for all applicable purposes.

### BACKGROUND

### Field of the Disclosure

Aspects of the present disclosure relate to wireless communications, and more particularly, to techniques for reducing the latency of scheduling requests in wireless communications networks.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a user equipment, comprising: determining an amount of data to be sent to a network entity; selecting a resource for sending a scheduling request based on the amount of data; and sending, to the network entity, a scheduling request using the selected resource.

Another aspect provides a method of wireless communications by a network entity, comprising: receiving a scheduling request using a preconfigured resource, wherein the preconfigured resource is one of a plurality of preconfigured resources, each respective preconfigured resource of the plurality of preconfigured resources being associated with a respective amount of data for an uplink transmission; and sending an uplink grant, wherein the uplink grant indicates one or more uplink resources for sending an amount of data associated with the preconfigured resource to the network entity.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example of a non-terrestrial.

FIGS. 6A and 6B depict example architectures for non-terrestrial networks.

FIG. 7 depicts a process flow for communications in a network between a user equipment and a network entity.

FIG. 8A depicts another process flow for communications in a network between a user equipment and a network entity.

FIG. 8B depicts an example table of scheduling request resources.

FIG. 9 depicts a method for wireless communications.

FIG. 10 depicts a method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for reducing the latency of scheduling requests in wireless communications networks.

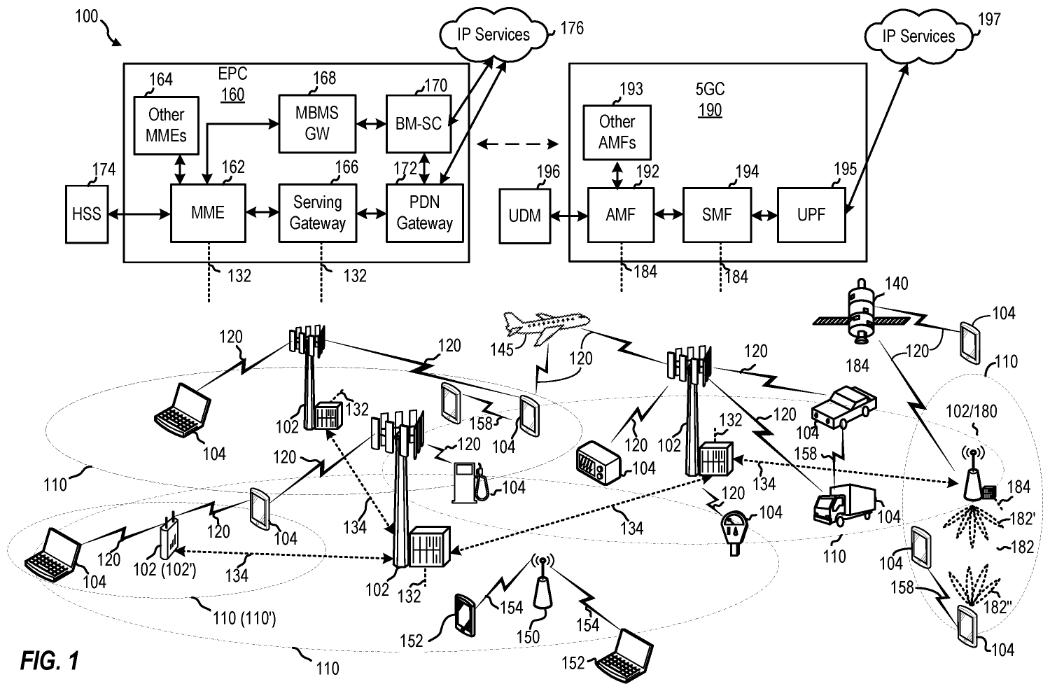

Generally, before data is transmitted by a user equipment, it is sent to a buffer to await scheduling and transmission. When data arrives in a transmission buffer of a user equipment (e.g., an L2 buffer), the user equipment may not yet have uplink resource(s) scheduled by a wireless communications network with which to send the buffered data. Accordingly, the user equipment may send a scheduling request to the network, such as that described with respect to FIG. 1, requesting resources for transmitting the buffered data.

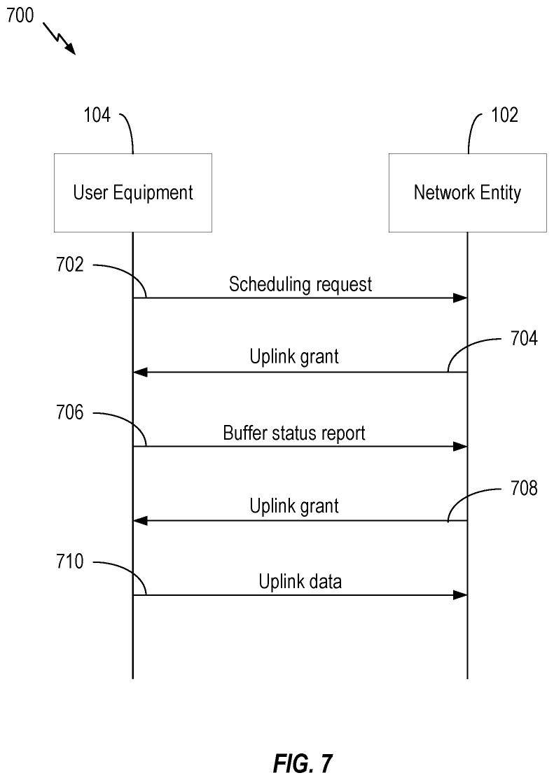

Generally, the scheduling requests acts as a basic indication that the user equipment needs uplink resources from the network, but the network generally cannot determine, based on the received scheduling request, the extent of resources required by the user equipment. Accordingly, the network will generally schedule a first uplink resource grant for the user equipment that is just large enough for the user equipment to send a buffer status report indicating the status of its transmission buffer. When the network receives the buffer status report from the user equipment, it may then schedule a second uplink resource grant with sufficient resources to send the data buffered by the user equipment and waiting for transmission. Upon receiving the grant, the user equipment may schedule and subsequently transmit the buffered data. FIG. 7, which is described in further detail below, depicts an example of this procedure. Notably, this scheduling procedure requires two transmissions and receptions between the user equipment and the network (e.g., “round trips”) before the user equipment is able to initiate transmitting the buffered data.

In a terrestrial network, the aforementioned procedure may have sufficiently low latency in most scenarios despite the multiple scheduling data round trips due to the proximity of the user equipment to the network entity, such as a base station. For example, the average round trip delay in a terrestrial network may be on the order of 2 milliseconds (ms) per round trip, or 4 ms overall for the aforementioned procedure. However, for a non-terrestrial network, where the user equipment and network entity may be separated by significant distances, the round trip delay may grow several orders of magnitude.

For example, a non-terrestrial network using satellite-based network entities (e.g., base stations) may have a round-trip time of around 500 ms for geosynchronous satellites, which means around 1000 ms of total latency for the aforementioned scheduling procedure. As another example, for low earth orbit satellites, a round-trip may take between 8 ms and 25 ms depending on orbit, which is still more than four times (in the best case) the terrestrial round-trip time. Such delays may create significant performance issues in data transmissions between the user equipment and the network, thereby reducing network efficiency and user experience.

Aspects described herein overcome this technical problem by associating particular scheduling request resources with particular buffered data size ranges (at the user equipment) so that the first scheduling request sent by a user equipment to a network can identify not only the user equipment's need for an uplink resource, but also an indication of the size of the needed grant.

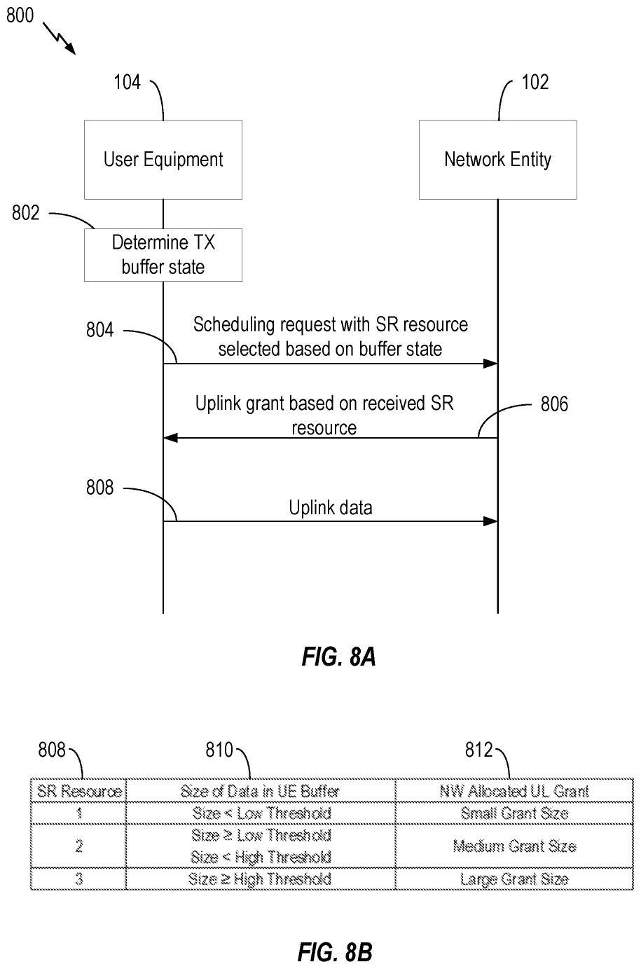

By way of simple example, a first configured scheduling request resource may be associated with an amount of data in a user equipment's transmission buffer that is below a first threshold value. A second configured scheduling request resource may be associated with an amount of data in the user equipment's transmission buffer that is between the first threshold value and a second threshold value. A third configured scheduling request resource may be associated with an amount of data in the user equipment's transmission buffer that is more than the second threshold value. FIGS. 8A and 8B, described in further detail below, depicts an example of this improved method. Accordingly, by transmitting a scheduling request using a selected scheduling request resource this is associated with a particular transmission data buffer state, the user equipment notifies the network of both its need for uplink resources and the relative size of that need, and beneficially omits the need to send a buffer status report or other secondary transmission indicating the size of its intended transmission.

The reduction of the second round trip, compared to the conventional method for scheduling uplink resources described above, cuts the latency for the scheduling procedure in half. Thus, the speed of communications between the user equipment and the network are improved and the efficiency of the network is improved by reducing the overhead associated with the conventional need for multiple round trips to schedule uplink data.

The methods described herein for reducing the latency of resource scheduling procedures are beneficial not only for traditionally high latency communications systems, such a non-terrestrial networks, but also for latency-sensitive communications services for terrestrial networks, such as ultra-reliable low-latency communication (URLLC) services.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device. For example, various functions of a network as well as various devices associated with and interacting with a network may be considered network entities.

In the depicted example, wireless communications network 100 includes base stations (BSs) 102, user equipments (UEs) 104, and one or more core networks, such as an Evolved Packet Core (EPC) 160 and 5G Core (5GC) network 190, which interoperate to provide communications services over various communications links, including wired and wireless links. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

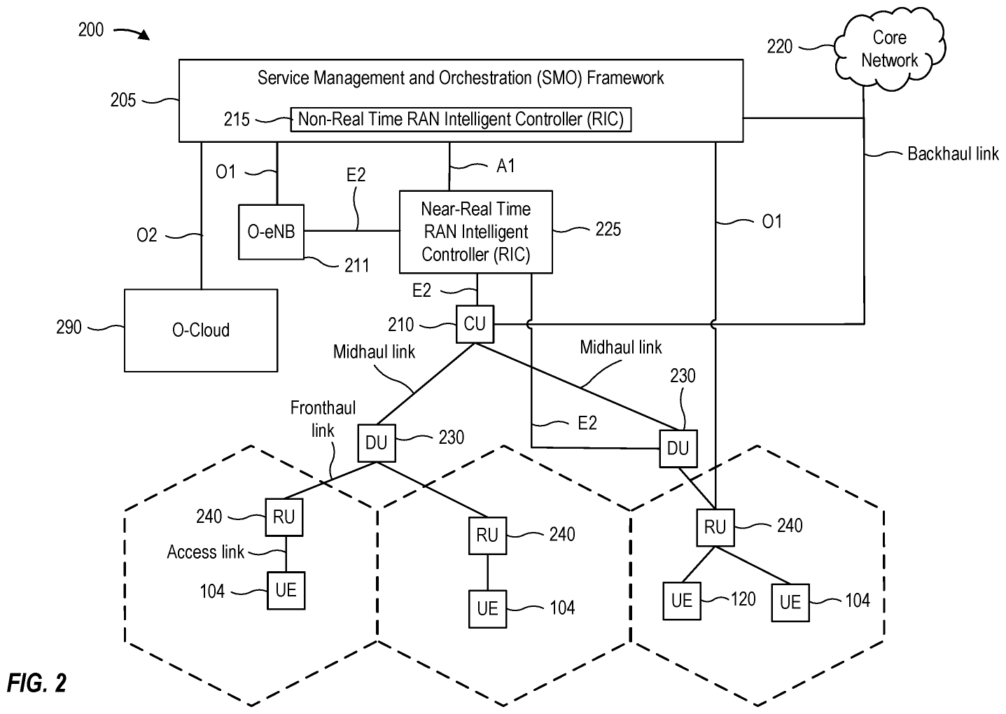

While BSs 102 are depicted in various aspects as unitary communications devices, BSs 102 may be implemented in various configurations. For example, one or more components of base station may be disaggregated, including a central unit (CU), one or more distributed units (DUs), one or more radio units (RUs), a radio unit (RU), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHZ-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. BS 180 may also receive the beamformed signal from UE 104 in one or more receive directions 182′. Base station 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communications with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172 in the depicted example. MME 162 may be in communications with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communications with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

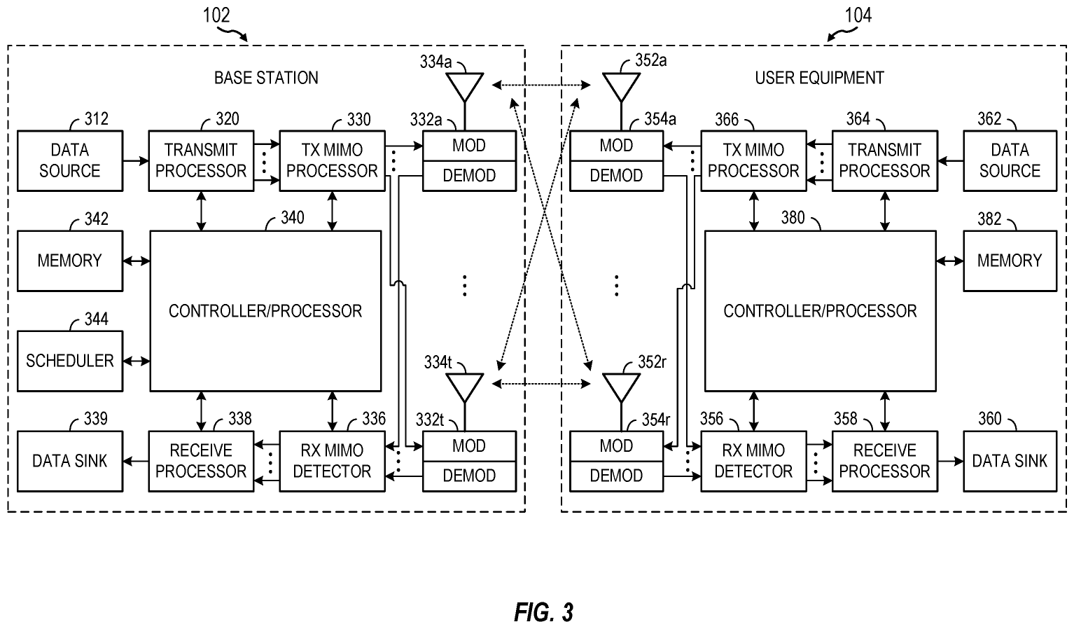

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., data source 362) and wireless reception of data (e.g., data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and other aspects described herein.

In some aspects, a processor may be configured to perform various operations, such as those associated with the methods described herein, and transmit (output) to or receive (obtain) data from another interface that is configured to transmit or receive, respectively, the data.

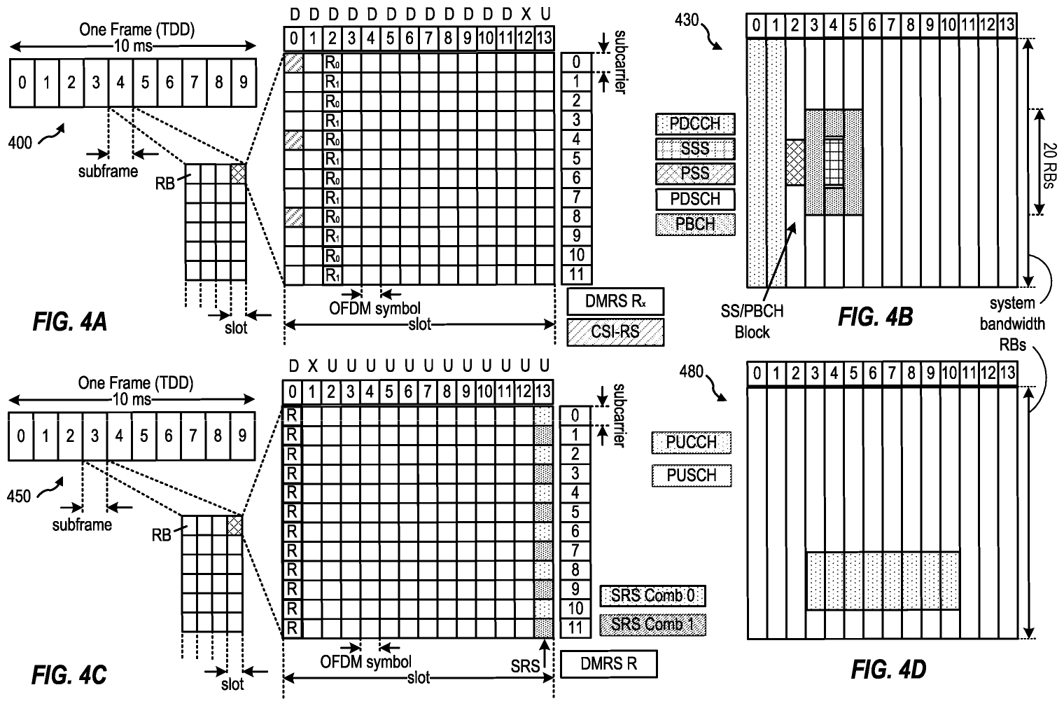

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and in the time domain with SC-FDM.

A wireless communications frame structure may be frequency division duplex (FDD), in which for a particular set of subcarriers and subframes within the set of subcarriers are dedicated for either DL or UL. Wireless communications frame structures may also be time division duplex (TDD), in which for a particular set of subcarriers and subframes within the set of subcarriers are dedicated for both DL and UL.

In FIGS. 4A and 4C, the wireless communications frame structure is TDD where Dis DL, U is UL, and X is flexible for use between DL/UL. UEs may be configured with the slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot configuration. Subframes may also include mini-slots, which generally have fewer symbols than an entire slot. Other wireless communications technologies may have a different frame structure and/or different channels.

Generally, the number of slots within a subframe is based on a slot configuration and a numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 us.

As depicted in FIGS. 4A, 4B, 4C, and 4D, a resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and channel state information reference signals (CSI-RS) for channel estimation at the UE. The RS may also include beam measurement RS (BRS), beam refinement RS (BRRS), and phase tracking RS (PT-RS).

FIG. 4B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may also transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Non-Terrestrial Networks

In some cases, communications in a wireless communications network, such as the wireless communications network 100 illustrated in FIG. 1, may be facilitated by one or more non-terrestrial devices. In such cases, this wireless communications network may be referred to as a non-terrestrial network (NTN). Non-terrestrial devices may include, for example, devices such as a space satellite (e.g., satellite 140 in FIG. 1), a balloon, a dirigible, an airplane (e.g., airplane 145 in FIG. 1), a drone, an unmanned aerial vehicle, and/or the like.

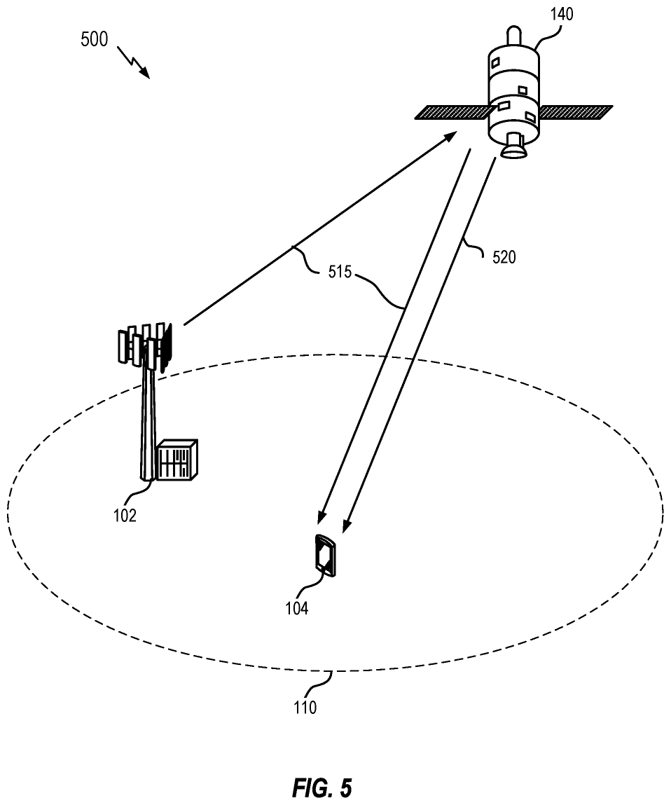

FIG. 5 depicts an example of an non-terrestrial network 500 including satellite 140, in which aspects of the present disclosure may be practiced. In some examples, the non-terrestrial network 500 may implement aspects of the wireless communication network 100. For example, the non-terrestrial network 500 may include BS 102, UE 104, and satellite 140. BS 102 may serve a coverage area or cell 110 in cases of a terrestrial network, and satellite 140 may serve the coverage area or cell 110 in cases of a non-terrestrial network. Some non-terrestrial networks may employ airborne platforms (e.g., a drone or balloon) and/or space borne platforms (e.g., a satellite).

The satellite 140 may communicate with the BS 102 and UE 104 as part of wireless communications in the non-terrestrial network 500. In cases of a terrestrial network, the UE 104 may communicate with the BS 102 over a communication link (e.g., communication link 120 in FIG. 1). In the case of non-terrestrial network wireless communications, the satellite 140 may be the serving cell for the UE 104 via a communication links 520 (e.g., communication link 120 in FIG. 1). In certain aspects, the satellite 140 may act as a relay for the BS 102 and the UE 104, relaying both data transmission and control signaling 515.

The UE 104 may determine to connect to the satellite 140 using a random access (RA) procedure (e.g., a four-step RA procedure or a two-step RA procedure). The initiation of the RA procedure may begin with the transmission of a RA preamble (e.g., an NR preamble for RA) by the UE 104 to the satellite 140 or BS 102. The UE 104 may transmit the RA preamble on a physical random access channel (PRACH). In some PRACH designs, there may be no estimation or accounting for the RTD or the frequency shift associated with non-terrestrial networks. In certain networks, such as terrestrial NR networks (e.g., 5G NR), SSBs transmitted by a cell are transmitted on the same frequency interval (e.g., occupying the same frequency interval). In non-terrestrial network 500, a satellite may use multiple antennas to form multiple narrow beams and the beams may operate on different frequency intervals to mitigate interference among the beams.

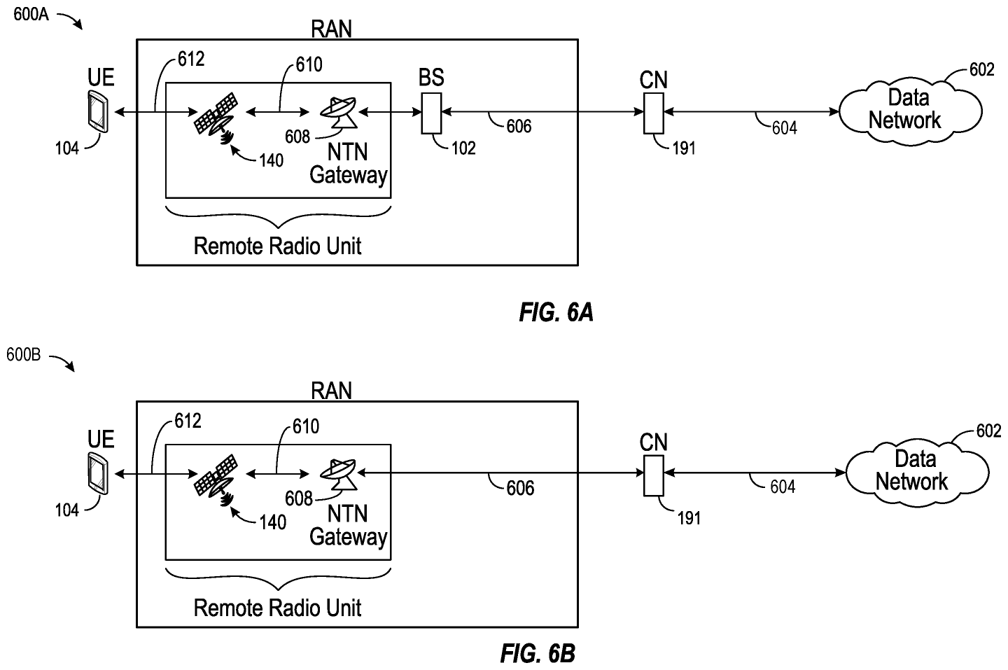

In some cases, different architectures may exist for non-terrestrial networks, such as a transparent satellite based non-terrestrial network architecture and a regenerative satellite based non-terrestrial network architecture. An example of the transparent satellite based non-terrestrial network architecture is illustrated in FIG. 6A while an example of the regenerative satellite based non-terrestrial network architecture is illustrated in FIG. 6B. In some cases, the non-terrestrial network architectures shown in FIGS. 6A and 6B may be implemented in the non-terrestrial network 500 shown in FIG. 5.

In general, the transparent satellite based non-terrestrial network architecture (e.g., also known as a bent-pipe satellite architecture, such as depicted in FIG. 6A) involves the satellite 140 receiving a signal from a BS 102 by way of a non-terrestrial network gateway 608 and relaying the signal to a UE 104 in this example (or another BS 102 in another example). In the regenerative satellite based non-terrestrial network architecture (such as depicted in FIG. 6B), satellite 140 may be configured to relay signals like the bent-pipe architecture, but may also use on-board processing to perform other functions, such as demodulating a received signal, decoding a received signal, re-encoding a signal to be transmitted, or modulating the signal to be transmitted, or a combination thereof.

For example, as shown in FIG. 6A, in a transparent satellite-based non-terrestrial network architecture 600A, communication between data network 602 and UE 104 may begin with data being sent from data network 602 over a communication link 604 to a user plane function (UPF) in core network 191, such as the UPF 195 in 5GC 190 illustrated in FIG. 1. In some cases, communication link 604 between data network 602 and the UPF in the core network 191 may be implemented with an N6 interface. Thereafter, the data may be forwarded from the core network 191 to BS 102 via a communication link 606, which in some aspects may be an NG interface. The data may then be sent by the BS 102 to the UE 104 on another interface, such as a Uu interface, via an non-terrestrial network gateway 608 and satellite 140. For example, the non-terrestrial network gateway 608 may receive the data from the BS 102 and may forward the data to the satellite 140 on a feeder link via a satellite radio interface (SRI). The SRI on the feeder link is some examples is a Uu interface. Thereafter, satellite 140 may perform radio frequency filtering, frequency conversion, and amplification on the received data before relaying the data to the UE 104 on a service link 612 (e.g., via a Uu interface). Hence, the satellite 140 in the transparent satellite based non-terrestrial network architecture 600A merely repeats the data on the Uu radio interface from the feeder link 610 (between the non-terrestrial network gateway 608 and the satellite 140) to the service link 612 (e.g., between the satellite 140 and the UE 104) and vice versa. In other words, the data is un-changed by the satellite 140 and is simply relayed to the UE 104.

In the regenerative satellite based non-terrestrial network architecture 600B illustrated in FIG. 6B, the data from the data network 602 may be sent from the core network 191 directly to the satellite 140 via non-terrestrial network gateway 608 without first being processed by BS 102 (as in FIG. 6A). For example, the non-terrestrial network gateway 608 may send the data to the satellite 140 on a feeder link 610 that implements a SRI. After receiving the data, satellite 140 may perform radio frequency filtering, frequency conversion and amplification as well as demodulation/decoding, switching and/or routing, and coding/modulation. In other words, satellite 140 may implement functions of a BS (e.g., BS 102) on-board satellite 140. Thereafter, satellite 140 transmits the data to the UE 104 on, for example, a Uu radio interface via a service link 612 between UE 104 and satellite 140.

### Aspects Related to Reduced Latency Scheduling Request Procedures

Aspects described herein provide scheduling request resources configured to indicate data transmission needs by a transmitting device, such as a user equipment. Beneficially, such scheduling requests allow a network to determine an amount of data (e.g., relatively or absolutely) the transmitting device wishes to transmit to the network without having to perform additional communications specific to determining the amount of data. Rather, the use of a particular resource acts as both an indication of a need to transmit data as well as an indication of how much data is intended to be transmitted.

Aspects described herein beneficially improve the speed of communications between transmitting devices (e.g., user equipments) and receiving devices (e.g., network entities) while also reducing communications overhead and thereby improving network efficiency and utilization. Aspects described herein are beneficial for any wireless communication network, including traditionally high latency communications systems, such a non-terrestrial networks, as well as latency-sensitive communications services for terrestrial networks, such as ultra-reliable low-latency communication (URLLC) services.

FIG. 7 depicts an example flow 700 of a conventional scheduling procedure in which user equipment 104 requests resources from a network (e.g., by way of network entity 102) in order to transmit data to the network.

Flow 700 begins at step 702 with user equipment 104 sending a scheduling request to network entity 102. As above, this first (or initial) scheduling request acts as a basic indication that user equipment 104 needs uplink resources from the network.

Because the network (e.g., via network entity 102) cannot determine, based on the received scheduling request at step 702, the amount of uplink transmission resources required by user equipment 104, it sends a first uplink resource grant to user equipment 104 via network entity 102 at step 704 that is sufficient for user equipment to send a buffer status report to the network.

User equipment then utilizes the first uplink grant to send a buffer status report to network entity 102 indicating the status of its transmission buffer.

When the network receives the buffer status report from the user equipment at step 706 (e.g., via network entity 102), it may then schedule a second uplink resource grant with sufficient resources for user equipment 104 to send the data buffered and waiting for transmission (as represented in the buffer status report). At step 708, network entity 102 sends the second uplink resource grant to user equipment 104.

After receiving the second uplink resource grant, user equipment 104 sends the buffered data using the granted uplink resources at step 708.

As depicted in FIG. 7, this conventional scheduling procedure requires two transmissions and receptions between user equipment 104 and network entity 102, and thus two communication round trips (steps 702 and 704 followed by steps 706 and 708) before user equipment 104 is able to transmit its buffered data at step 710.

FIG. 8A depicts a process flow 800 for communications in a network between network entity 102 and a user equipment 104 for reducing latency in scheduling requests. In some aspects, the network entity 102 may be an example of the base station 102 depicted and described with respect to FIGS. 1 and 3. Similarly, the user equipment 104 may be an example of user equipment 104 depicted and described with respect to FIGS. 1 and 3. However, in other aspects, user equipment 104 may be another type of wireless communications device and network entity 102 may be another type of network entity or network node, such as those described herein.

Flow 800 begins at step 802 with user equipment 104 determining its transmission buffer state. In one example, user equipment 104 may determine the present state of one or more transmission buffers, such as an amount of data currently stored in the one or more transmission buffers. However, a present determination of the buffer state may not be reflective of how much data will be buffered by the time user equipment is able to actually transmit the data. Accordingly, in another example, user equipment 104 may determine an expected or target state of the one or more transmission buffers at some future point in time.

By way of example, user equipment 104 may determine based on system information broadcast (SIB) parameters a type and/or a distance of a network entity. In the case of a non-terrestrial network entity, the type may be “satellite” (e.g., satellite 140 in FIG. 5) and the distance may be based on an orbiting altitude (e.g., 22,236 miles for a satellite in geosynchronous orbit). Based on this information, user equipment 104 can calculate an approximate round trip time for communications (e.g., around 540 ms for a satellite in geosynchronous orbit). In conjunction with this determination, user equipment may estimate the expected data accumulation (e.g., in the one or more transmission buffers) during the roundtrip (e.g., steps 804 and 806 in FIG. 8A). In some cases, an application layer of user equipment 104 may estimate the expected data accumulation.

For example, in case of a voice call, user equipment may determine that 30 byte packets will be generated every 20 ms, and thus for a round trip time of 540 ms, then user equipment 104 will accumulate around 810 bytes in the one or more transmission buffers.

Flow 800 then proceeds to step 804 with user equipment 104 sending a scheduling request to network entity 102 using a scheduling request (SR) resource that indicates to the network an amount of data user equipment 104 intends to send. For example, the scheduling request resource could be any of the resources 1-3 in the example of FIG. 8B.

Generally, the indication of the amount of data may be a relative indication, such a range of data (e.g., from x bytes to y bytes), or a specific indication (e.g., z bytes). For example, FIG. 8B depicts a simple example in which scheduling request resources 1-3 (in column 808) are each configured to indicate an amount of data in a user equipment's buffer (as indicated in column 810). Based on receiving any of the configured scheduling request resources, a network may then allocate uplink resources based on the indicated amount of data (as indicated in column 812).

Specifically, in the example of FIG. 8B, a first configured scheduling request resource (in row 1 of the table) indicates that an amount of data in user equipment 104's transmission buffer is below a first threshold value, which is referred to as a “low threshold” in this example. Accordingly, when receiving the first configured scheduling request resource (e.g., SRR_1), the network may allocate an uplink grant that is sized according to the data threshold, which is a “small grant size” in this example. In one example, a small grant size may be equal to or less than the low threshold (e.g., in terms of bits, bytes, or the like).

A second configured scheduling request resource (in row 2 of the table) indicates that an amount of data in user equipment 104's transmission buffer is between the first threshold value and a second threshold value, which is referred to as a “high threshold” in this example. Accordingly, when receiving the second configured scheduling request resource (e.g., SRR_2), the network may allocate an uplink grant that is sized according to the data threshold, which is a “medium grant size” in this example. In one example, a medium grant size may be equal to or greater than the low threshold and less than the high threshold.

A third configured scheduling request resource (in row 3 of the table) indicates that an amount of data in user equipment 104's transmission buffer is more than the second threshold value. Accordingly, when receiving the second configured scheduling request resource (e.g., SRR_3), the network may allocate an uplink grant that is sized according to the data threshold, which is a “large grant size” in this example. In one example, a large grant size may be equal to or greater than the high threshold.

More generally, the network may define and configure any number of grant sizes associated with any number of scheduling request resources. Thus, the example table in FIG. 8B may have any number of rows and associated thresholds or other definitions (e.g., relative versus specific indications of buffer size).

In some aspects, the network (e.g., via network entity 102) may configure a user equipment (e.g., 104) with predefined scheduling request resources (such as in the example of FIG. 8B) dynamically via messaging, such as RRC messaging. In other aspects, user equipment 104 may include a preconfigured set of predefine scheduling resources. In some cases, a network may overwrite or update the preconfigured set of predefined scheduling request resources dynamically.

Flow 800 then proceeds to step 806 where network entity 102 sends an uplink grant to user equipment 104 based on the scheduling request resource received from user equipment 104 in step 804.

Finally, flow proceeds to step 808 where user equipment 104 sends data to network entity 102 using the uplink resources granted at step 806.

As compared to the example in FIG. 7, in FIG. 8A, there is only one round trip of communications (steps 804 and 806) before user equipment 104 is able to transmit data, which thus reduces the latency of communications and reduces overhead for the communications, thereby increasing the network efficiency of the communications as described above. Further yet, because user equipment 104 needs to make fewer communications, it reduces power use and extends battery life when user equipment 104 is a mobile device. Similarly, where network entity 102 is a non-terrestrial network entity, such as a satellite, the total power budget for communications may be reduced by eliminating unnecessary round trip communications.

### Example Operations of a User Equipment

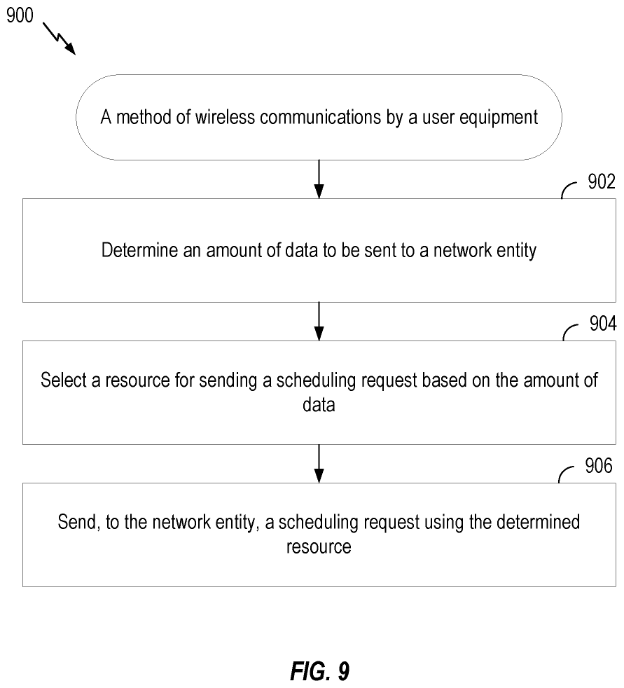

FIG. 9 shows a method 900 for wireless communications by a UE, such as UE 104 of FIGS. 1 and 3.

Method 900 begins at step 902 with determining an amount of data to be sent to a network entity.

In some aspects, determining the amount of data to be sent to a network entity comprises determining the amount of data stored in a data buffer within the user equipment. In some aspects, the data buffer comprises a layer 2 (L2) transmit buffer.

In some aspects, determining the amount of data to be sent to a network entity comprises determining an estimated amount of data stored in a data buffer after a scheduling request interval. In some aspects, the scheduling request interval comprises a first time interval associated with sending the scheduling request to the network entity and a second time interval associated with receiving an uplink grant from the network entity.

Method 900 then proceeds to step 904 with selecting a resource for sending a scheduling request based on the amount of data.

In some aspects, selecting the resource for sending the scheduling request based on the amount of data comprises selecting the resource from a plurality of preconfigured resources, and each respective preconfigured resource of the plurality of preconfigured resources is associated with a respective range of data amounts.

Method 900 then proceeds to step 906 with sending to the network entity, a scheduling request using the selected resource.

In some aspects, method 900 further includes receiving, from the network entity, an uplink grant that indicates one or more uplink resources for sending the amount of data to the network entity.

In some aspects, method 900 further includes sending the amount of data to the network entity using the one or more uplink resources indicated by the uplink grant.

In some aspects, method 900 further includes receiving, from the network entity, a configuration indicating the plurality of preconfigured resources. In some aspects, the configuration is received via radio resource control (RRC) signaling.

In some aspects, method 900 further includes receiving a system information block message from the network entity; estimating a distance of the network entity from the user equipment based on the system information block message; and estimating the first time interval and the second time interval based on the estimated distance of the network entity from the user equipment.

In some aspects, method 900 further includes selecting the resource for sending the scheduling request based further on a type of the network entity. In some aspects, the network entity comprises a non-terrestrial network entity, such as a satellite, an airplane, or the like. In some aspects, the network entity comprises a terrestrial network entity, such as fixed installation base station. In some aspects, the network entity comprises a terrestrial mobile network entity, such as a mobile base station (or aspect of a base station).

In some aspects, method 900 further includes determining the type of the network entity based on a received system information block (SIB) message from the network entity.

In some aspects, method 900 further includes selecting the resource for sending the scheduling request based further on a type of data service between the user equipment and the network entity. In some aspects, the data service comprises an ultra-reliable low latency communication service.

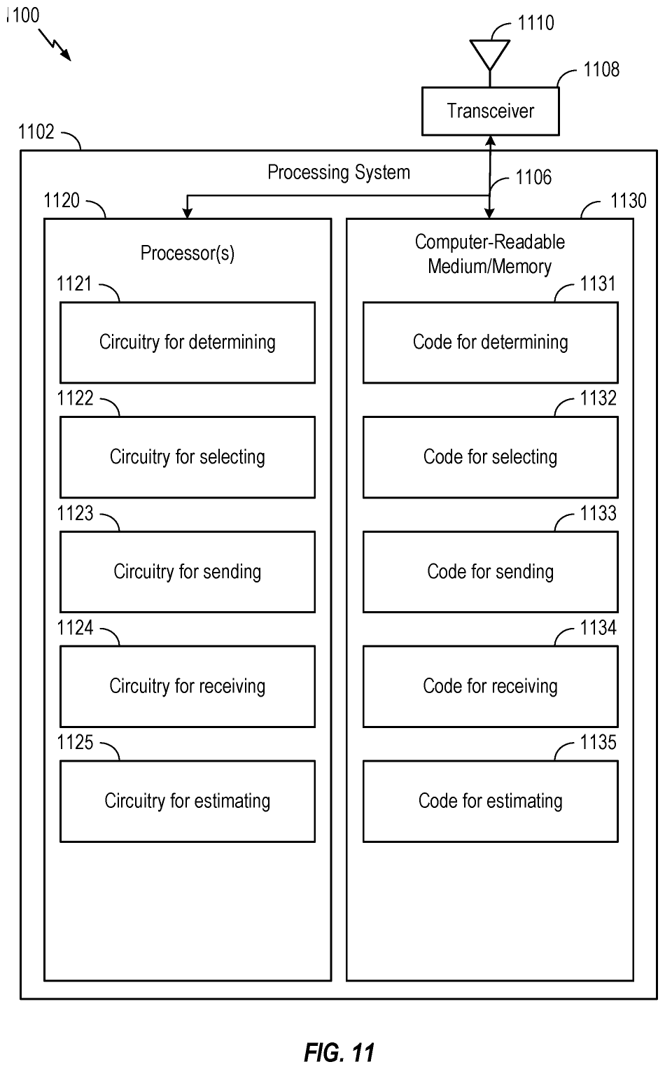

In one aspect, method 900, or any aspect related to it, may be performed by an apparatus, such as communications device 1100 of FIG. 11, which includes various components operable, configured, or adapted to perform the method 900. Apparatus 1100 is described below in further detail.

Note that FIG. 9 is just one example of a method, and other methods including fewer, additional, or alternative steps are possible consistent with this disclosure.

### Example Operations of a Network Entity

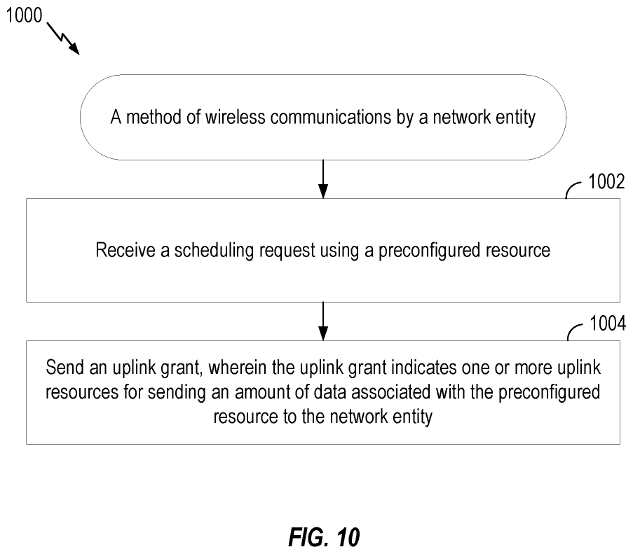

FIG. 10 shows a method 1000 for wireless communications by a network entity, such as BS 102 of FIGS. 1 and 3, or a disaggregated base station as discussed with respect to FIG. 2.

Method 1000 begins at step 1002 with receiving (e.g., from a user equipment) a scheduling request using a preconfigured resource. In some aspects, the preconfigured resource is one of a plurality of preconfigured resources, each respective preconfigured resource of the plurality of preconfigured resources being associated with a respective amount of data for an uplink transmission. In some aspects, each respective amount of data is associated with a range of data amounts, such as described with respect to the example in FIG. 8B.

Method 1000 then proceeds to step 1004 with sending (e.g., to the user equipment) an uplink grant. In some aspects, the uplink grant indicates one or more uplink resources for sending an amount of data associated with the preconfigured resource to the network entity. For example, as described with respect to FIG. 8B, a preconfigured resource, such as SR resources 1-3, can indicate an amount of data that a user equipment has (or expects to have) buffered and waiting to be sent to the network entity.

In some aspects, method 1000 further includes receiving the amount of data using the one or more uplink resources indicated by the uplink grant. For example, the amount of data may be received from a user equipment, as in the example of FIG. 8A.

In some aspects, method 1000 further includes sending a configuration indicating the plurality of preconfigured resources. In some aspects, the configuration is sent via radio resource control (RRC) signaling. For example, the configuration may be sent to a user equipment.

In some aspects, method 1000 further includes sending a system information block message (e.g., to a user equipment), wherein the system information block message indicates an attribute of the network entity. In some aspects, the attribute is a distance from the network entity to a user equipment. In some aspects, the attribute is a type of the network entity. In some aspects, the network entity comprises a non-terrestrial network entity, such as a satellite, an airplane, or the like. In some aspects, the network entity comprises a terrestrial network entity, such as fixed installation base station. In some aspects, the network entity comprises a terrestrial mobile network entity, such as a mobile base station (or aspect of a base station). The method of claim 19, wherein network entity receives the amount of data via an ultra-reliable low latency communication service.

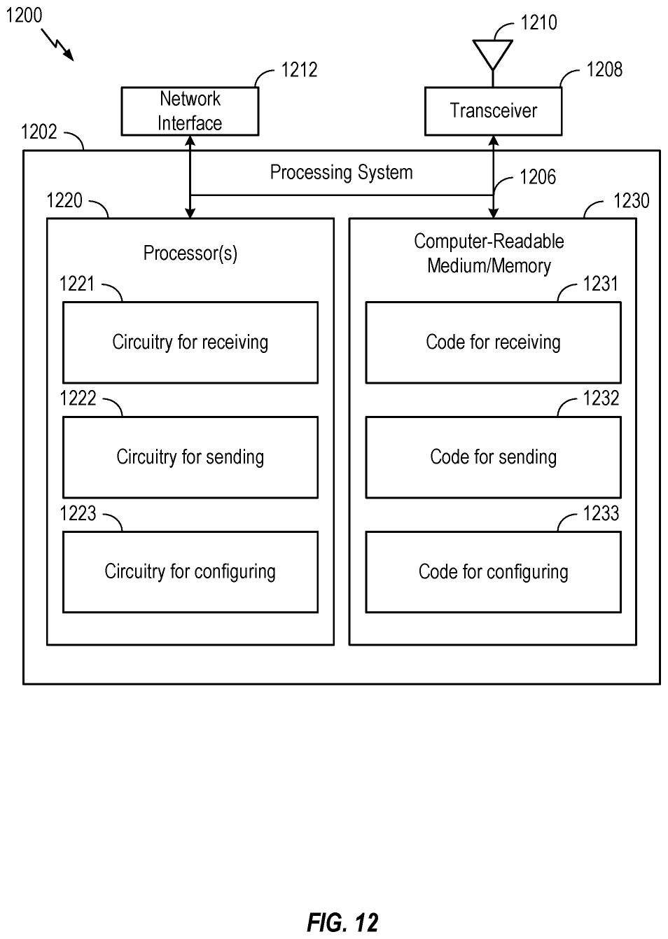

In one aspect, method 1000, or any aspect related to it, may be performed by an apparatus, such as communications device 1200 of FIG. 12, which includes various components operable, configured, or adapted to perform the method 1000. Apparatus 1200 is described below in further detail.

Note that FIG. 10 is just one example of a method, and other methods including fewer, additional, or alternative steps are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 358, transmit processor 364, TX MIMO processor 366, and/or controller/processor 380, as described with respect to FIG. 3. The one or more processors 1120 are coupled to a computer-readable medium/memory 1130 via a bus 1106. In certain aspects, the computer-readable medium/memory 1130 is configured to store instructions (e.g., computer-executable code) that when executed by the one or more processors 1120, cause the one or more processors 1120 to perform the method 900 described with respect to FIG. 9, or any aspect related to it. Note that reference to a processor performing a function of communications device 1100 may include one or more processors performing that function of communications device 1100.

In the depicted example, computer-readable medium/memory 1130 stores code (e.g., executable instructions) for determining 1131, code for selecting 1132, code for sending 1133, code for receiving 1134, and code for estimating 1135. Processing of the code 1131-1135 may cause the communications device 1100 to perform the method 900 described with respect to FIG. 9, or any aspect related to it.

The one or more processors 1120 include circuitry configured to implement (e.g., execute) the code stored in the computer-readable medium/memory 1130, including circuitry for determining 1121, circuitry for selecting 1122, circuitry for sending 1123, circuitry for receiving 1124, and circuitry for estimating 1125. Processing with circuitry 1121-1125 may cause the communications device 1100 to perform the method 900 described with respect to FIG. 9, or any aspect related to it.

Various components of the communications device 1100 may provide means for performing the method 900 described with respect to FIG. 9, or any aspect related to it. For example, means for transmitting, sending or outputting for transmission may include the transceivers 354 and/or antenna(s) 352 of the UE 104 illustrated in FIG. 3 and/or transceiver 1108 and antenna 1110 of the communications device 1100 in FIG. 11. Means for receiving or obtaining may include the transceivers 354 and/or antenna(s) 352 of the UE 104 illustrated in FIG. 3 and/or transceiver 1108 and antenna 1110 of the communications device 1100 in FIG. 11.

FIG. 12 depicts aspects of an example communications device.

The communications device 1200 includes a processing system 1202 coupled to a transceiver 1208 (e.g., a transmitter and/or a receiver) and/or a network interface 1212. The transceiver 1208 is configured to transmit and receive signals for the communications device 1200 via an antenna 1210, such as the various signals as described herein. The network interface 1212 is configured to obtain and send signals for the communications device 1200 via communications link(s), such as a backhaul link, midhaul link, and/or fronthaul link as described herein, such as with respect to FIG. 2. The processing system 1202 may be configured to perform processing functions for the communications device 1200, including processing signals received and/or to be transmitted by the communications device 1200.

The processing system 1202 includes one or more processors 1220. In various aspects, one or more processors 1220 may be representative of one or more of receive processor 338, transmit processor 320, TX MIMO processor 330, and/or controller/processor 340, as described with respect to FIG. 3. The one or more processors 1220 are coupled to a computer-readable medium/memory 1230 via a bus 1206. In certain aspects, the computer-readable medium/memory 1230 is configured to store instructions (e.g., computer-executable code) that when executed by the one or more processors 1220, cause the one or more processors 1220 to perform the method 1000 described with respect to FIG. 10, or any aspect related to it. Note that reference to a processor of communications device 1200 performing a function may include one or more processors of communications device 1200 performing that function.

In the depicted example, the computer-readable medium/memory 1230 stores code (e.g., executable instructions) for receiving 1231, code for sending 1232, and code for configuring 1233. Processing of the code 1231-1233 may cause the communications device 1200 to perform the method 1000 described with respect to FIG. 10, or any aspect related to it.

The one or more processors 1220 include circuitry configured to implement (e.g., execute) the code stored in the computer-readable medium/memory 1230, including circuitry for receiving 1221, circuitry for sending 1222, and circuitry for configuring 1223. Processing with circuitry 1221-1223 may cause the communications device 1200 to perform the method 1000 as described with respect to FIG. 10, or any aspect related to it.

Various components of the communications device 1200 may provide means for performing the method 1000 as described with respect to FIG. 10, or any aspect related to it. Means for transmitting, sending or outputting for transmission may include the transceivers 332 and/or antenna(s) 334 of the BS 102 illustrated in FIG. 3 and/or transceiver 1208 and antenna 1210 of the communications device 1200 in FIG. 12. Means for receiving or obtaining may include the transceivers 332 and/or antenna(s) 334 of the BS 102 illustrated in FIG. 3 and/or transceiver 1208 and antenna 1210 of the communications device 1200 in FIG. 12.

### Example Clauses

Implementation examples are described in the following numbered clauses:
Clause 1: A method of wireless communications by a user equipment, comprising: determining an amount of data to be sent to a network entity; selecting a resource for sending a scheduling request based on the amount of data; and sending, to the network entity, a scheduling request using the selected resource.
Clause 2: The method of Clause 1, further comprising receiving, from the network entity, an uplink grant that indicates one or more uplink resources for sending the amount of data to the network entity.
Clause 3: The method of Clause 2, further comprising sending the amount of data to the network entity using the one or more uplink resources indicated by the uplink grant.
Clause 4: The method of any one of Clauses 1-3, wherein: selecting the resource for sending the scheduling request based on the amount of data comprises selecting the resource from a plurality of preconfigured resources, and each respective preconfigured resource of the plurality of preconfigured resources is associated with a respective range of data amounts.
Clause 5: The method of Clause 4, further comprising receiving, from the network entity, a configuration indicating the plurality of preconfigured resources.
Clause 6: The method of Clause 5, wherein the configuration is received via radio resource control (RRC) signaling.
Clause 7: The method of any one of Clauses 1-6, wherein determining the amount of data to be sent to a network entity comprises determining the amount of data stored in a data buffer within the user equipment.
Clause 8: The method of Clause 7, wherein the data buffer comprises an L2 transmit buffer.
Clause 9: The method of any one of Clauses 1-8, wherein determining the amount of data to be sent to a network entity comprises determining an estimated amount of data stored in a data buffer after a scheduling request interval.
Clause 10: The method of Clause 9, wherein the scheduling request interval comprises a first time interval associated with sending the scheduling request to the network entity and a second time interval associated with receiving an uplink grant from the network entity.
Clause 11: The method of Clause 10, further comprising: receiving a system information block message from the network entity; estimating a distance of the network entity from the user equipment based on the system information block message; and estimating the first time interval and the second time interval based on the estimated distance of the network entity from the user equipment.
Clause 12: The method of any one of Clauses 1-11, further comprising selecting the resource for sending the scheduling request based further on a type of the network entity.
Clause 13: The method of Clause 12, further comprising determining the type of the network entity based on a received system information block (SIB) message from the network entity.
Clause 14: The method of Clause 12, wherein the network entity comprises a non-terrestrial network entity.
Clause 15: The method of Clause 14, wherein the non-terrestrial network entity comprises a satellite.
Clause 16: The method of any one of Clauses 1-15, further comprising selecting the resource for sending the scheduling request based further on a type of data service between the user equipment and the network entity.
Clause 17: The method of Clause 16, wherein the data service comprises an ultra-reliable low latency communication service.
Clause 18: A method of wireless communications by a network entity, comprising: receiving a scheduling request using a preconfigured resource, wherein the preconfigured resource is one of a plurality of preconfigured resources, each respective preconfigured resource of the plurality of preconfigured resources being associated with a respective amount of data for an uplink transmission; and sending an uplink grant, wherein the uplink grant indicates one or more uplink resources for sending an amount of data associated with the preconfigured resource to the network entity.
Clause 19: The method of Clause 18, further comprising receiving the amount of data from the user equipment using the one or more uplink resources indicated by the uplink grant.
Clause 20: The method of any one of Clauses 18-19, further comprising sending, to the user equipment, a configuration indicating the plurality of preconfigured resources.
Clause 21: The method of Clause 20, wherein the configuration is sent via radio resource control (RRC) signaling.
Clause 22: The method of any one of Clauses 18-21, further comprising:
sending, to the user equipment, a system information block message, wherein the system information block message indicates an attribute of the network entity.
Clause 23: The method of Clause 22, wherein the attribute is a distance from the network entity to a user equipment.
Clause 24: The method of Clause 22, wherein the attribute is a type of the network entity.
Clause 25: The method of any one of Clauses 18-24, wherein the network entity comprises a non-terrestrial network entity.
Clause 26: The method of Clause 25, wherein the non-terrestrial network entity comprises a satellite.
Clause 27: The method of any one of Clauses 19-26, wherein network entity receives the amount of data via an ultra-reliable low latency communication service.
Clause 28: The method of any one of Clauses 18-27, wherein each respective amount of data is associated with a range of data amounts.
Clause 29: An apparatus, comprising: a memory comprising executable instructions; and a processor configured to execute the executable instructions and cause the apparatus to perform a method in accordance with any one of Clauses 1-28.
Clause 30: An apparatus, comprising means for performing a method in accordance with any one of Clauses 1-28.
Clause 31: A non-transitory computer-readable medium comprising executable instructions that, when executed by a processor of an apparatus, cause the apparatus to perform a method in accordance with any one of Clauses 1-28.
Clause 32: A computer program product embodied on a computer-readable storage medium comprising code for performing a method in accordance with any one of Clauses 1-28.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications by a user equipment, comprising:
one or more memories comprising executable instructions; and
one or more processors configured to execute the executable instructions and cause the UE to:
determine an amount of data to be sent to a network entity;
select a resource for sending a scheduling request based on the amount of data; and
send, to the network entity, a scheduling request using the selected resource.

2. The apparatus of claim 1, wherein the one or more processors are further configured to cause the UE to receive, from the network entity, an uplink grant that indicates one or more uplink resources for sending the amount of data to the network entity.

3. The apparatus of claim 2, wherein the one or more processors are further configured to cause the UE to send the amount of data to the network entity using the one or more uplink resources indicated by the uplink grant.

4. The apparatus of claim 1, wherein:
selecting the resource for sending the scheduling request based on the amount of data comprises selecting the resource from a plurality of preconfigured resources, and
each respective preconfigured resource of the plurality of preconfigured resources is associated with a respective range of data amounts.

5. The apparatus of claim 4, wherein the one or more processors are further configured to cause the UE to receive, from the network entity, a configuration indicating the plurality of preconfigured resources.

6. The apparatus of claim 5, wherein the configuration is received via radio resource control (RRC) signaling.

7. The apparatus of claim 1, wherein determining the amount of data to be sent to a network entity comprises determining the amount of data stored in a data buffer within the user equipment.

8. The apparatus of claim 7, wherein the data buffer comprises an L2 transmit buffer.

9. The apparatus of claim 1, wherein determining the amount of data to be sent to a network entity comprises determining an estimated amount of data stored in a data buffer after a scheduling request interval.

10. The apparatus of claim 9, wherein the scheduling request interval comprises a first time interval associated with sending the scheduling request to the network entity and a second time interval associated with receiving an uplink grant from the network entity.

11. The apparatus of claim 10, wherein the one or more processors are further configured to cause the UE to:
receive a system information block message from the network entity;
estimate a distance of the network entity from the user equipment based on the system information block message; and
estimate the first time interval and the second time interval based on the estimated distance of the network entity from the user equipment.

12. The apparatus of claim 1, wherein the one or more processors are further configured to cause the UE to select the resource for sending the scheduling request based further on a type of the network entity.

13. The apparatus of claim 12, wherein the one or more processors are further configured to cause the UE to determine the type of the network entity based on a received system information block (SIB) message from the network entity.

14. The apparatus of claim 12, wherein the network entity comprises a non-terrestrial network entity.

15. The apparatus of claim 14, wherein the non-terrestrial network entity comprises a satellite.

16. The apparatus of claim 1, wherein the one or more processors are further configured to cause the UE to select the resource for sending the scheduling request based further on a type of data service between the user equipment and the network entity.

17. The apparatus of claim 16, wherein the data service comprises an ultra-reliable low latency communication service.

18. A method for wireless communications, comprising:
determining an amount of data to be sent to a network entity;
selecting a resource for sending a scheduling request based on the amount of data; and
sending, to the network entity, a scheduling request using the selected resource.

19. An apparatus for wireless communications by a network entity, comprising:
one or more memories comprising executable instructions; and
one or more processors configured to execute the executable instructions and cause the network entity to:
receive a scheduling request using a preconfigured resource, wherein the preconfigured resource is one of a plurality of preconfigured resources, each respective preconfigured resource of the plurality of preconfigured resources being associated with a respective amount of data for an uplink transmission; and
send an uplink grant, wherein the uplink grant indicates one or more uplink resources for sending an amount of data associated with the preconfigured resource to the network entity.

20. (canceled)

21. The apparatus of claim 19, wherein the one or more processors are further configured to cause the network entity to send a configuration indicating the plurality of preconfigured resources

22-30. (canceled)
